(19) United States
(12) Patent Application Publication
(10) Pub. No.: US 2026/0274567 A1
(43) Pub. Date: Sep. 17, 2026

(54) TRACK ASSEMBLY APPARATUS

(71) Applicant: Ocado Innovation Limited, Hatfield, Hertfordshire (GB)

(72) Inventor: Ian PARKS, Hatfield (GB)

(21) Appl. No.: 19/667,796

(22) Filed: May 5, 2026

Related U.S. Application Data
(63) Continuation of application No. PCT/EP2024/081784, filed on Nov. 8, 2024.

(30) Foreign Application Priority Data
Nov. 10, 2023 (GB) 2317305.7

(51) Int. Cl. B65G 1/04

(52) U.S. Cl. CPC B65G 1/0464

(57) ABSTRACT

A grid framework structure for supporting one or more robotic load handling devices operative on the grid framework structure, the grid framework structure including a supporting framework structure comprising a plurality of prefabricated frames arranged in a three dimensional grid pattern with modular storage cells for the storage of a plurality of stacks of containers where adjacent modular storage cells share a common prefabricated frame; and a track system for guiding movement of the one or more robotic load handling devices on the grid framework structure, the track system being mounted to the supporting framework structure and comprising a plurality of tracks arranged in a grid pattern where each of the plurality of modular storage cells supports a sub-group of two or more grid cells of the track system.

### RELATED APPLICATIONS

This application is a continuation application of International Patent Application No. PCT/EP2024/081784 filed 8 Nov. 2024 and entitled “Track Assembly Apparatus,” which claims priority to UK Patent Application No. GB 2317305.7 filed 10 Nov. 2023 and entitled “Track Assembly Apparatus”; the entire contents of both of which applications are incorporated herein by reference.

### TECHNICAL FIELD

The present invention relates to the field of remotely operated load handling devices on tracks located on a grid framework structure for handling storage containers or bins stacked in the grid framework structure, more specifically to a track assembly apparatus.

### BACKGROUND

Storage and retrieval systems 1 comprising a three-dimensional storage grid structure, within which storage containers/bins/totes are stacked on top of each other, are well known. PCT Publication No. WO2015/185628A (Ocado) describes a known storage and fulfilment system in which stacks of bins or containers are arranged within a grid framework structure. The bins or containers are accessed by load handling devices operative on tracks located on the top of the grid framework structure. A system of this type is illustrated schematically in FIGS. 1 to 3 of the accompanying drawings.

As shown in FIGS. 1 and 2, stackable containers, known as storage bins, containers or totes 10, are stacked on top of one another to form stacks 12. The stacks 12 are arranged in a grid framework structure 14 in a warehousing or manufacturing environment. The grid framework structure is made up of a plurality of storage columns or grid columns. Each grid in the grid framework structure has at least one grid column for storage of a stack of containers. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application.

The grid framework structure 14 comprises a plurality of vertical uprights or upright members or upright columns 16 that support horizontal members 18, 20. A first set of parallel horizontal grid members 18 is arranged perpendicularly to a second set of parallel horizontal members 20 in a grid pattern to form a track system or grid structure or grid 15 comprising a plurality of grid cells 17. Each grid cell in the grid framework structure has at least one grid column for storage of a stack of containers. For the avoidance of doubt, the term “grid framework structure” is used to mean a three-dimensional structure within which the storage containers are stored, and the terms “track system”, “grid structure” and “grid” are used interchangeably to mean the two-dimensional structure in a substantially horizontal plane upon which the load handling devices operate. The grid cell has an opening to allow a load handling device to lift a container or storage bin through the grid cell. In the track system, the first set of parallel horizontal grid members 18 intersect the second set of parallel horizontal grid members at nodes. The track system is supported by the upright members 16 at each of the nodes or at the point where the grid members intersect such that the upright members are interconnected at their tops ends by the intersecting grid members. The grid members 16, 18, 20 are typically manufactured from metal and typically welded or bolted together or a combination of both. The storage bins or containers 10 are stacked between the upright members 16 of the grid framework structure 14, so that the upright members 16 guard against horizontal movement of the stacks 12 of bins 10, and guide vertical movement of the storage bins 10. The grid framework structure can be considered as a rectilinear assemblage of vertical or upright columns supporting a grid formed from the intersecting horizontal grid members, i.e. a four wall shaped dimensional framework.

The top level of the grid framework structure 14 comprises a grid or grid structure which includes rails or tracks 22 arranged in a grid pattern across the top of the stacks 12 to define a track system. Referring additionally to FIG. 3, the rails or tracks 22 support and guide a plurality of load handling devices 30. The track system comprises a first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

The upright columns of the grid framework structure are interconnected at their top ends by the rails or tracks intersecting in the grid. The intersections of the rails or tracks in the grid structure are generally termed ‘nodes’ of the grid structure. Typically, the first and second set of rails comprise individual elongated rail or track sections that are interconnected together in the first and second direction at the interconnections where the track or rail sections meet at the top ends of the upright columns. The rails or tracks typically comprise an elongated element which is profiled to guide a load handling device on the grid structure and are typically profiled to provide either a single track surface so as to allow a single load handling device to travel on the track, or a double track so as to allow two load handling devices to pass each other on the same track. In the case where the elongated element is profiled to provide a single track, the track comprises opposing lips (one lip on one side of the track and another lip at the other side of the track) along the length of the track to guide or constrain each wheel from lateral movement on the track. In the case where the profile of the elongated element is a double track, the track comprises two pairs of lips along the length of the track to allow the wheels of adjacent load handling devices to pass each other in both directions on the same track. To provide two pairs of lips, the track typically comprises a central ridge or lip and a lip either side of the central ridge. In all cases, when traversing on the grid structure, the wheels of the load handling device are constrained on both sides or faces of the wheels of the load handling device.

The track or rail can be a separate component to the grid member (referred to as a ‘track support’) or alternatively, the track is integrated into the grid member as a single body, i.e. forms part of the grid member. For example, each of the first and second sets of horizontal grid members 18, 20 of the grid structure can function as a track support and the first and second sets of tracks of the track system can be mounted to the grid structure for guiding the load handling devices in two dimensions on the grid structure.

WO2018/146304 (Autostore Technology AS) teaches a rail arrangement for wheeled vehicles in a storage system, where the rail arrangement comprises a first set of parallel rails and a second set of parallel rails. The first and second sets of parallel rails form a grid where the second set is arranged perpendicular to the first set and intersect the first set at their crossroads, thus forming a grid of parallel rails. The crossroads of the intersecting rails correspond to the interconnections of the upright columns. Each of the rails of both sets of rails comprises two parallel tracks adapted for guiding the wheels of the vehicles or load handling devices. The rails or tracks comprise a number of longitudinal segments or sections with two edge ridges running along each longitudinal edge of the longitudinal segments and a central ridge running parallel with the edge ridges. The area between the ridges forms the tracks for receiving and guiding the wheels of the vehicles. The width of the central ridge is adapted to ensure that two vehicles can pass each other when running on the tracks in different directions on the same segment. The edge ridges of each intersecting rail are in contact with each other, forming a corner ridge. The corner ridges are arranged tightly connected in order to prevent the vehicle from snagging at the joints. In order for the vehicles have a smooth drive across the intersections, the corner ridges are rounded at the insides.

A known load handling device 30 shown in FIGS. 4 and 5 comprising a vehicle body 32 is described in PCT Patent Publication No. WO2015/019055 (Ocado) and corresponding U.S. Pat. No. 10,000,337, the entire content of which is hereby incorporated by reference, where each load handling device 30 only covers one grid space of the grid framework structure 14. Here, the load handling device 30 comprises a wheel assembly comprising a first set of wheels 34 consisting of a pair of wheels on the front of the vehicle body 32 and a pair of wheels 34 on the back of the vehicle 32 for engaging with the first set of rails or tracks to guide movement of the device in a first direction, and a second set of wheels 36 consisting of a pair of wheels 36 on each side of the vehicle 32 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction, e.g. X or Y direction on the track system.

The load handling device 30 is equipped with a lifting device or crane mechanism to lift a storage container from above. The crane mechanism comprises a winch tether or cable 38 wound on a spool or reel (not shown) and a grabber device 39 in the form of a lifting frame. The lifting frame is usually made of the metal, e.g. steel or aluminium, and has a rectilinear or square shape corresponding to the cross-sectional shape of the storage container. The lifting device comprises a set of lifting tethers 38 extending in a vertical direction and connected nearby or at the four corners of the lifting frame 39, otherwise known as the grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2. A lifting drive mechanism such as a motor drives rotation of the spool or reel to raise or lower the grabber device.

The wheels 34, 36 are arranged around the periphery of a cavity or recess, known as a container-receiving recess or container receiving space 41, in the lower part. The recess is sized to accommodate the container 10 when it is lifted by the crane mechanism, as shown in FIGS. 5A-5B. When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device. The container receiving space may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS) in which case the container receiving space is located below a cantilever of the load handing device. In this case, the grabber device is hoisted by a cantilever such that the grabber device is able to engage and lift a container from a stack into a container receiving space below the cantilever.

To ensure stability of the grid framework structure, prior art storage systems are largely dependent on various supports and bracing arranged within or at least partly along the periphery of the grid framework structure. However, the use of various supports and bracing (anti-movement braces) to stabilise the grid framework structure from internal and external forces is disadvantageous for a number of reasons. The grid framework structure occupies space or area which could be utilised to store containers, in that it prevents optimum usage of available space or area for the storage of containers. The need of a supporting structure may limit the available options for positioning of the grid framework structure since any auxiliary grid supporting structure often requires connection to a surrounding structure such as the inner walls of a building. The requirement of a supporting structure to stabilise the grid framework structure is generally not cost efficient and occupies useful storage space.

To erect the grid framework structure in the art, a plurality of vertical uprights are individually positioned one piece at a time in a grid-like pattern on the ground. The assembling of individual vertical uprights together one piece at a time is sometimes referred to as “stick-built” structures. The “stick-built” approach of the assembling the grid framework structure requires numerous time-consuming adjustments to be made for reliable operation of the robotic load handling devices on the tracks. The height of the vertical uprights and thus the level of the grid mounted thereon is adjusted by one or more adjustable feet at the base or bottom end of each of the vertical uprights. A sub-group of the vertical uprights are braced together to provide structural stability to the grid framework structure. The vertical uprights are interconnected at their top ends by grid members so that the grid members adopt the same grid pattern as the vertical uprights, i.e. the vertical uprights support the grid members at the point or node where each of the grid members intersect in the grid pattern. For the purpose of explanation of the present invention, the points or junctions where the grid members intersect or are interconnected constitute the nodes of the grid structure and correspond to the area where the grid structure is supported by a vertical upright. The resultant grid framework structure can be considered as a free standing rectilinear assemblage of upright columns supporting the grid formed from intersecting horizontal grid members, i.e. a four wall shaped framework.

The arrangement of the vertical uprights provides multiple vertical storage columns for the storage of one or more containers in a stack. The status quo in the industry is to guide the grabber device and a storage container connected to the grabber device along the corners of the grabber device and/or storage container. The vertical uprights supporting the track system help to guide the grabber device of the lifting mechanism as the grabber device engages with a container within the grid framework structure and is lifted towards the load handling device operative on the grid. The size of the grid framework structure and thus the ability to store containers containing different items or stock keeping units (SKUs) is largely dependent on the number of vertical uprights spanning over a given footprint of the grid framework structure. However, one of the biggest bottlenecks in the building of a fulfilment or distribution centre is the erection of the grid framework structure. The time and cost to assemble the grid framework structure represents a huge proportion of the time and cost to build a fulfilment or distribution centre. One of the biggest and the most time consuming operations involves erecting the vertical uprights individually and fixing the track system to the vertical uprights.

A track assembly apparatus that mitigates the above problems is therefore required to fix the track system to the vertical uprights.

### SUMMARY OF INVENTION

Aspects of the invention are set out in the accompanying claims.

A grid framework structure for supporting one or more robotic load handling devices operative on the grid framework structure, the grid framework structure comprising:
i) a supporting framework structure comprising a plurality of prefabricated frames arranged in a three dimensional grid pattern comprising a plurality of modular storage cells for the storage of a plurality of stacks of containers such that adjacent modular storage cells share a common prefabricated frame, each of the plurality of prefabricated frames lying in a vertical plane and comprising a plurality of vertical members braced by one or more horizontal bracing members;
ii) a track system for guiding movement of the one or more robotic load handling devices on the grid framework structure, the track system being mounted to the supporting framework structure and comprising a plurality of tracks arranged in a grid pattern comprising a plurality of grid cells extending across the plurality of modular storage cells such that each of the plurality of modular storage cells supports a sub-group of two or more grid cells of the track system;
wherein the grid framework structure comprises one or more adjustment mechanisms interposed between the one or more horizontal bracing members of the supporting framework structure and the track system for adjusting the level of the track system on the supporting framework structure.

The adjustment mechanism allows the level of the track system on the supporting framework structure to be adjusted by adjusting the separation between the track system and the supporting framework structure. This is important because the track structure comprises a plurality tracks. The joint at the intersections may present a small step to an oncoming vehicle travelling on the rails or tracks. When a load handling device being guided on the track system approaches a track joint at the intersections, the wheels of the vehicle may snag or strike the edge of the rails or tracks as the vehicle crosses the sets of rails. Although the vertical displacement of the wheel of the load handling device is minute as the load handling device travels across the intersections, this up and down bumping impact to the wheels is one of the main source of noise and vibration of the travelling load handling device. In a worst case scenario, the bumping of the wheels on the rails or tracks imparts wear and tear not only to the wheels or tires of the load handling device but also to the rails or tracks to the extent that damage occurs to either or both of the wheels and the rails. Thus, by using each adjustment mechanism to adjust the height or level of each overlying track, this ensures that the plurality of tracks provide a smooth surface, i.e. with no or minimal height different between each track, such that a load handling device can be guided around the track system without vertically displacing its wheels.

Each adjustment mechanism can be adjusted in situ i.e. between the one or more horizontal bracing members of the supporting framework structure and the track system, meaning that adjustment can easily be carried out, thereby reducing the time and cost to assemble the grid framework structure. In particular, adjustment of the track system can be carried out towards the end of the process of installation of the grid framework structure without needing to adjust any of the other constituents of the grid framework structure. This has an advantage that fewer operators are needed to measure and adjust the track level.

The level of the track system is adjusted by adjusting the separation between the track system and the supporting framework structure. Specifically, the level of the track system may be adjusted by adjusting the separation between one or more horizontal bracing members of the supporting framework structure and the track system.

In addition to adjusting the separation between the track system and the supporting framework structure, the adjustment mechanisms provide additional support to the track support to withstand the weight of the load handling devices operating above. The one or more adjustment mechanisms may be positioned between the nodes of the track system, where typically the track supports are weaker. In particular, if each track support in the first set and the second set of track supports extends across the entire length or width of the track system, it is important to support the sections of the track supports between the intersections where the weight of load handling devices may cause sagging or bending in these regions. Thus, by providing adjustment mechanisms along the length and width of the track system, the track supports are provided with additional support to withstand the weight of the load handling devices operating above.

Optionally, the track system may further comprise a plurality of track supports arranged in a grid pattern comprising a first set of track supports extending in a first direction and a second set of track supports extending in a second direction, the second direction being substantially perpendicular to the first direction such that the first set of track supports intersect the second set of track supports at one or more nodes in the track system, and wherein the one or more adjustment mechanisms are interposed between the one or more horizontal bracing members of the supporting framework structure and the plurality of track supports. By mounting the track system to a track support, the track support bears at least a portion or the full weight of the load handling device operative on the plurality of tracks, thus allowing the plurality of tracks to be fabricated from a les structurally supporting material. This is because the plurality of tracks do not need to be composed of materials that give sufficient load bearing capability, e.g. metal. Each track support of the plurality of track supports may extend from one side of the track system to the other side of the track system. Thus by adjusting the level of each side of each track support with an adjustment mechanism, this ensures that the plurality of tracks rest on a level surface and therefore the plurality of tracks do not move vertically as a load handling device travels over them.

The track support may comprise an H-shaped cross sectional profile. The H-shaped cross sectional profile may comprise a pair of opposing vertical sides, a pair of horizontal flanges and a U-shaped portion located centrally and interiorly between the pair of opposing vertical sides. The U-shaped portion may comprise a pair of vertical edges extending parallel to and interiorly to the pair of vertical sides, and a horizontal edge extending between the pair of vertical edges. The horizontal edge may be positioned approximately centrally of the H-shaped cross-sectional profile. Each track support may be rotated 180 degrees such that the track system comprises a first set of track supports extending in a first direction comprising track supports in which the U-shaped portion faces upwards, and a second set of track supports extending in a second direction comprising a track supports in which the U-shaped portion faces downwards. Each adjustment mechanism may be positioned either beneath the U-shaped portion or within the U-shaped portion. Specifically, each adjustment mechanism may be positioned beneath the U-shaped portion when the U-shaped portion is facing upwards, and each adjustment mechanism may be positioned within the U-shaped portion when the U-shaped portion is facing downwards. Optionally, the one or more adjustment mechanisms may each comprise an upper part and a lower part, wherein the upper part and the lower part are moveable relative to each other in a vertical direction to enable the separation between the one or more horizontal bracing members and the track system to be adjusted. Thus the separation between the upper part and the lower part of each adjustment mechanism determines the separation between the one or more horizontal bracing members and the track system.

The one or more adjustment mechanisms may each comprise one or more openings, wherein at least one of the one or more openings is configured to threadingly engage with a threaded shaft. For example, the threaded shaft may be screw or bolt. The bolt or screw may be rotated within the opening in order to extend or retract a vertical distance between the upper part and the lower part of the adjustment mechanism. Alternatively, the threaded shaft may extend through the vertical height of the adjustment mechanism but not extend beyond an upper surface or a lower surface of the adjustment mechanism, i.e. the threaded shaft may be internally contained within the adjustment mechanism. In this arrangement, the threaded shaft may be hollow and comprise an interior passage which runs inside the vertical (z-direction) length of the threaded shaft. The interior passage may be threaded to allow an external screw to be fitted into the interior passage so that the threaded shaft can be rotated to increase or decrease the separation between the upper part and the lower part. Alternatively the interior passage may be shaped to fit an Allen key (or similar key, e.g., a hex key, star-drive key such as three-point, five-point, and/or six-point star keys, or keys having a hexalobular internal driving feature according to ISO 10664, etc.) so that when the key is fitted into the interior passage, the key can be rotated thereby increasing or decreasing the separation between the upper part and the lower part of the adjustment mechanism.

Optionally at least one of the one or more openings is configured to accommodate a guide pin. The guide pin may be used to vertically position the adjustment mechanism between the track system and the supporting framework structure. The upper part and the lower part may be separated by one or more spacers. The spacers allow the separation between the upper part and the lower part of the adjustment mechanism to be maintained. The spacers may be nuts or washers. Optionally, the one or more spacers may be slidingly engaged between the upper part and the lower part. In this arrangement, the threaded shaft within the adjustment mechanism can be rotated in either a clockwise or an anti-clockwise direction to adjust the distance between the upper and lower parts of the adjustment mechanism, and one or more spacers can be slid into the space between the upper and lower parts of the adjustment mechanism. Thus, there is no need to remove either the upper part or the lower part to insert the spacers between the upper part and the lower part of the adjustment mechanism, which therefore allows for easier adjustment.

Optionally, the track system further comprises one or more spacers interposed between the adjustment mechanism and the track supports and/or between the supporting framework structure and the adjustment mechanism. In this arrangement, the spacers are fitted above and/or below the adjustment mechanism.

The one or more adjustment mechanisms may be attachable to the one or more horizontal bracing members and the track system. The one or more adjustment mechanisms may each be attachable to the horizontal bracing members and the track system by one or more bolts and nuts. If the one or more adjustment mechanisms each comprise a threaded shaft internally contained in the adjustment mechanism, wherein the threaded shaft comprises a threaded interior passage, a screw may be threadingly engaged with the threaded interior passage to connect the adjustment mechanism to the underlying horizontal bracing member and a further screw may be threadingly engaged with the threaded interior passage to connect the adjustment mechanism to the overlying track support. Alternatively, each adjustment mechanism may be attachable to the supporting framework structure and a track support by two screws which fit into threaded openings within the adjustment mechanism, whereby one threaded opening extends from a top surface of the adjustment mechanism and one threaded opening extends from a bottom surface of the adjustment mechanism, such that the two threaded openings are separate from each other. Thus, in order to attach the adjustment mechanism to the underlying supporting framework structure, a screw is fitted through a hole in the supporting framework structure and fitted into the threaded opening extending from the bottom surface of the adjustment mechanism, and in order to attach the adjustment mechanism to the track support, a screw is fitted in a hole in the track support and fitted into the threaded opening extending from the top surface of the adjustment mechanism.

The one or more adjustment mechanisms may extend in the same direction as the underlying horizontal bracing member beneath the adjustment mechanism and in the same direction as the track system above the adjustment mechanism. For example, the one or more adjustment mechanisms may extend in a y-direction if the track supports and underlying horizontal bracing member extend in a y-direction, and/or the one or more adjustment mechanisms may extend in a x-direction if the track supports and underlying horizontal braving member extend in a x-direction. The one or more adjustment mechanisms may each have an elongate shape, such that the adjustment mechanism is long in relation to its width, therefore fewer adjustment mechanisms are required along the length of each track support and horizontal bracing member.

The one or more adjustment mechanisms may each comprise at least one raised positioning feature, and the plurality of track supports and the one or more horizontal bracing members may each comprise one or more holes for accommodating the at least one raised positioning feature of the one or more adjustment mechanisms. The accommodating holes in the supporting framework structure (in particular the horizontal bracing members) allows easy identification of where to position each adjustment mechanism, thereby enabling faster installation of the grid framework structure. The one or more adjustment mechanisms may each comprise a single raised positioning feature, which may, for example, be centrally located on the adjustment mechanism. The single raised positioning feature may extend from the top surface to the bottom surface of the adjustment mechanism such that the raised positioning feature is raised above the top surface of the adjustment mechanism and extends below the bottom surface of the adjustment mechanism.

Optionally, the at least one raised positioning feature comprises a pair of raised positioning features on a top surface of the adjustment mechanism and a pair of raised positioning features on a bottom surface of the adjustment mechanism. The pair of raised positioning features may be arranged on either side of the adjustment mechanism.

The one or more adjustment mechanisms may each comprise a plurality of raised positioning features. Each raised positioning feature may comprise a dome which protrudes from a top surface of the adjustment mechanism and/or a bottom surface of the adjustment mechanism. Each raised positioning feature may be positioned differently on the top surface compared to the bottom surface of the adjustment mechanism. For example, there may be three raised positioning features protruding from the top surface of the adjustment mechanism and five raised positioning features protruding from the bottom surface of the adjustment mechanism. Alternatively, there may be three raised positioning features protruding from the top surface of the adjustment mechanism and positioned on one side of the adjustment mechanism, While there may be three raised positioning features protruding from the bottom surface of the adjustment mechanism and positioned on an opposing side of the adjustment mechanism. The raised positioning features on the top surface may be shaped differently to the raised positioning features on the bottom surface, for example, the raised positioning features on the top surface may have a triangular profile, While the raised positioning features on the bottom surface may have a square profile, and the holes in the track support and the horizontal bracing member are shaped to accommodate the profile of the raised positioning features of the adjustment mechanism.

Optionally, each of the one or more adjustment mechanisms comprises steel, preferably cast steel. Cast steel is mechanically strong and can be easily formed into most shapes and sizes. The adjustment mechanism may be galvanised to prevent rusting.

The one or more adjustment mechanisms may comprise a plurality of adjustment assemblies. For example, there may be between 10 to 20 adjustment mechanisms in a grid framework structure, or between 21 to 30, or between 31 to 40, or between 41 to 50. Optionally, the plurality of adjustment mechanisms are spatially distributed or spaced apart in a direction along the length of the track system and/or one or more horizontal bracing members. The adjustment mechanisms may be evenly distributed i.e. positioned at regular intervals. Alternatively, the adjustment mechanisms may be unevenly distributed, for example there may be more adjustment mechanisms located closer to the free ends of the track supports. Optionally, each adjustment mechanism of the plurality of adjustment mechanisms is configured to adjust the level of at least a portion of the track system. For example, a single adjustment mechanism may be used to finely adjust the level of the track system at a first location, While a single adjustment mechanism at another location may be used to coarsely adjust the level of the track system at a second location by using one or more spacers, so that a load handling device can travel from the first location to the second location along one or more substantially horizontal tracks.

The one or more adjustment mechanisms may be positioned between nodes in the track system. Thus the one or more adjustment mechanisms provide additional support to the track supports, particularly the U-shaped portion of the track support, in regions where the track supports are likely to sag or bend due to the weight of the load handling devices operating above.

### DESCRIPTION OF DRAWINGS

These and other aspects of the invention will now be described, by way of example only, and with reference to the accompanying drawings, in which:

FIG. 1 is a schematic diagram of a known grid framework structure.

FIG. 2 is a schematic diagram of a top down view showing a stack of bins arranged within the framework structure of FIG. 1.

FIG. 3 is a schematic diagram of a load handling device operating on the grid framework structure.

FIG. 4 is a schematic perspective view of the load handling device showing the lifting device gripping a container from above.

FIGS. 5A and 5B are schematic perspective cut away views of the load handling device of FIG. 4 showing a container accommodated within the container receiving space of the load handling device and the container receiving space of the load handling device, respectively.

FIG. 6 is a top plan view of a section of a known grid structure comprising four adjoined grid cells showing the intersections or nodes of the grid members being supported by a vertical upright, each of the grid cells constituting a storage column.

FIG. 7 is a perspective view showing four vertical uprights making up a storage space or storage column within a grid framework structure.

FIG. 8 is a perspective view showing the arrangement of the tracks and track supports interconnected at their nodes or intersections by a cap plate.

FIG. 9 is a perspective view of a track support or grid member.

FIG. 10 is a perspective view of a cap plate for interconnecting the vertical uprights to the grid members at the nodes.

FIG. 11 is a perspective cross sectional view of the interconnection of the vertical uprights to the grid members by the cap plate at a node.

FIG. 12 is a perspective view of a track or rail.

FIG. 13 is a perspective view showing the assembled grid framework structure.

FIG. 14 is a perspective view showing a track system being mounted to a support structure

FIG. 15 is an illustration of the arrangement of track sections in a track system.

FIG. 16(a) is a cross-sectional profile of a track support.

FIG. 16(b) is a side view of the track support of FIG. 16(a).

FIG. 16(c) is a side view of the track support of FIGS. 16(a) and (b) rotated 180 degrees about the longitudinal axis.

FIG. 17(a) is a side view of the track support of FIGS. 16(b) and 16(c) intersecting at a node.

FIG. 17(b) is a closer view of the intersection shown in FIG. 17(a).

FIG. 17(c) is a cross-sectional profile of the intersection shown in FIGS. 17(a) and (b).

FIG. 18(a) is a perspective view of an adjustment mechanism.

FIG. 18(b) is a top view of the adjustment mechanism of FIG. 18(a).

FIG. 19(a) is a perspective view of an adjustment mechanism in a retracted state comprising a bolt and two guide pins.

FIG. 19(b) is a perspective view of the adjustment mechanism of FIG. 19(a) in an expanded state.

FIG. 20 is a top view of a shim for inserting either between the upper part and the lower part of the adjustment mechanism, or between the upper part of the adjustment mechanism and the track support, or between the lower part of the adjustment mechanism and a horizontal bracing member of the supporting framework structure.

FIG. 21 is a perspective view of an adjustment mechanism comprising a threaded shaft positioned in a central opening, the central opening being cut in half by the line J-J.

FIG. 22 is a side view of an adjustment mechanism positioned on a horizontal bracing member.

FIG. 23(a) is a perspective view of two adjustment mechanism positioned on a horizontal bracing member.

FIG. 23(b) is a perspective view of four adjustment mechanisms positioned on a horizontal bracing member.

FIG. 24(a) is a perspective view of an adjustment mechanism in position between a track support and a horizontal bracing member.

FIG. 24(b) is a perspective view of an adjustment mechanism in position between a track support that has been rotated 180 degrees along its longitudinal axis, and a horizontal bracing member.

FIG. 25 is a perspective view of the adjustment mechanism arrangement shown in FIG. 24(b) in an expanded state, and comprising one or more shims arranged between the upper part and the lower part of the adjustment mechanism.

FIG. 26(a) is a cross-sectional view of an alternative arrangement of the adjustment mechanism between the track support and a horizontal bracing member of the supporting framework structure.

FIG. 26(b) is a cross-sectional view of a further alternative arrangement of the adjustment mechanism between the track support and a horizontal bracing member of the supporting framework structure.

FIG. 27 is a perspective view of a track system comprising a track mounted on the track support of FIG. 16.

FIG. 28(a) is a perspective view of a track section for mounting onto the track support of FIG. 16.

FIG. 28(b) is a perspective view of the track section of FIG. 28(a) which is inverted.

### DETAILED DESCRIPTION

The following embodiments represent preferred examples of how the invention may be practised, but they are not necessarily the only examples of how this could be achieved. These examples are described in sufficient detail to enable those skilled in the art to practise the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation or use of the invention unless specifically set forth in the appended claims. Similarly connection references (e.g. attached, coupled, connected, joined, secured, and the like) are to be construed broadly and may include intermediate members between a connection of elements and relative motions between elements. As such, connection references do not necessary infer that two elements are directly connected and in fixed relation to each other, unless specifically set forth in the appended claims. Similarly, wording such as “movement in the n-direction” and any comparable wording, where n is one of x, y, or z, is intended to mean movement substantially along or parallel to the n-axis in either direction (i.e. towards the positive end of the n-axis or towards the negative end of the n-axis).

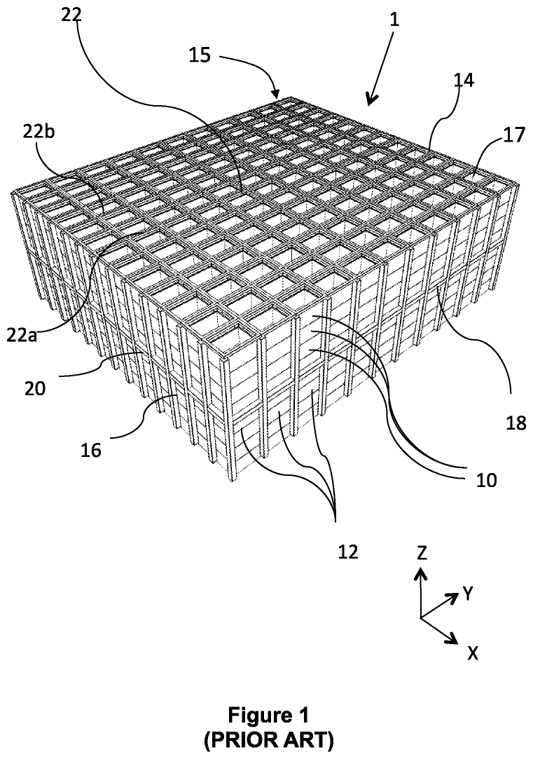

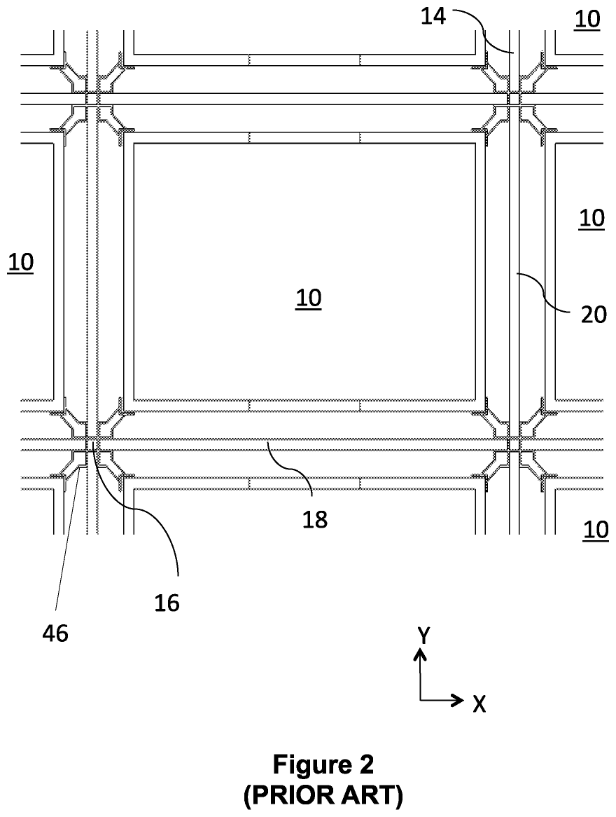

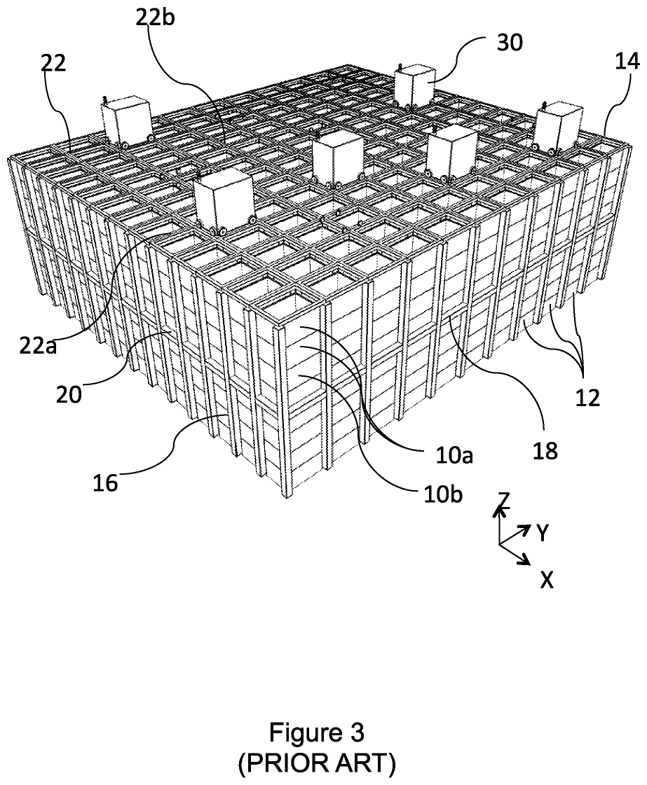

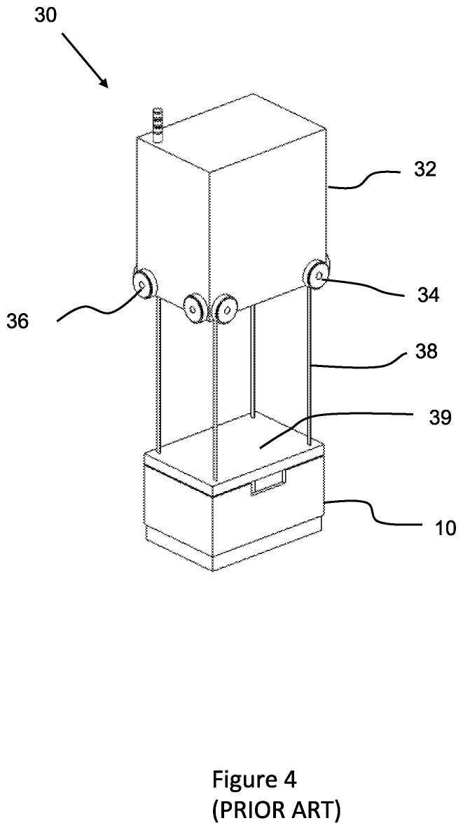

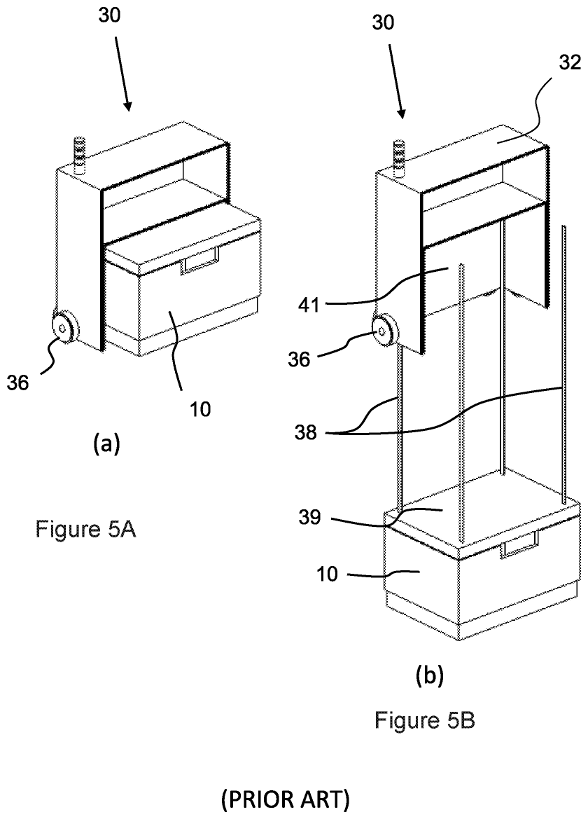

It is against the known features of the storage system such as the grid framework structure and the load handling device described above with reference to FIGS. 1 to 5, that the present invention has been devised.

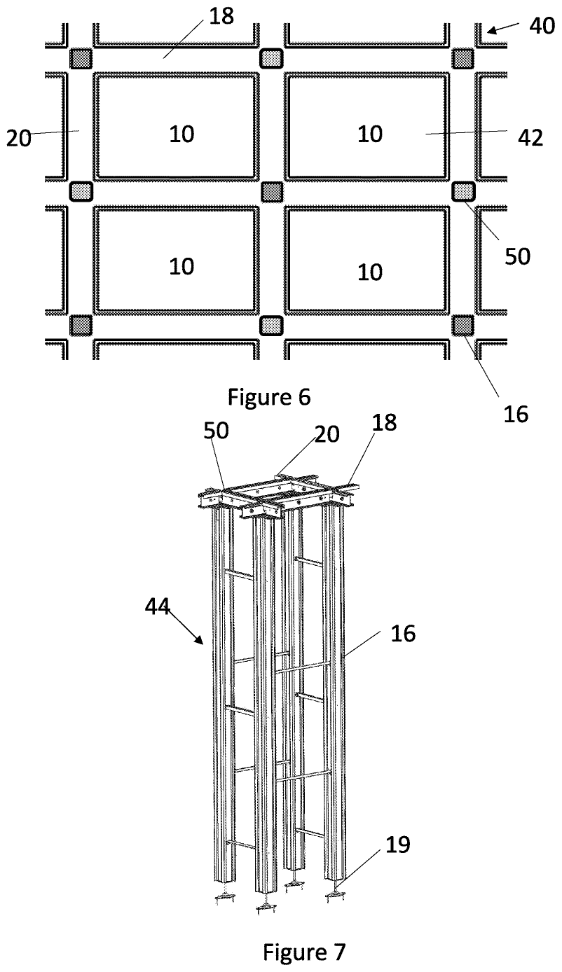

FIG. 6 shows a top view of a section or a portion of a traditional track system 40 comprising four adjoined grid cells 42 and FIG. 7 shows a perspective side view of a single grid cell 42 supported by four vertical uprights 16 to form a single storage column 44 for the storage of one or more containers 10 in a stack. The grid framework structure can be considered to be divided into a supporting framework structure comprising the plurality of vertical uprights and a track system. The track system is supported by the supporting framework structure and comprises a plurality of grid members arranged in a grid pattern comprising a plurality of grid cells.

FIG. 6 shows a series of horizontal intersecting beams or grid members 18, 20 arranged to form a plurality of rectangular frames constituting grid cells 42, more specifically a first a set of grid members 18 extending in a first direction x and a second set of grid members 20 extending in a second direction y, the second set of grid members 20 running transversely to the first set of grid members 18 in a substantially horizontal plane, i.e. the track system is represented by Cartesian coordinates in the X and Y direction. The term “vertical upright(s)”, “upright member(s)” and “upright column(s)” are used interchangeably in the description to mean the same thing. For the purpose of explanation of the present invention, the points or junctions where the grid members intersect or cross shown by the shaded squares in FIG. 6 can be defined as nodes or intersections 50. It is clearly apparent from the layout of at least a portion or section of a known track system 40 constituting four adjoining grid cells 42 shown in FIG. 6 that each intersection or node 50 of the track system 40 is supported by a vertical upright 16. From the section or at least a portion of the track system 40 shown in FIG. 6, the four adjoining grid cells are supported by nine vertical uprights 16, i.e. three sets of vertical uprights 16 supporting the track system at three rows, where each row comprises three nodes 50.

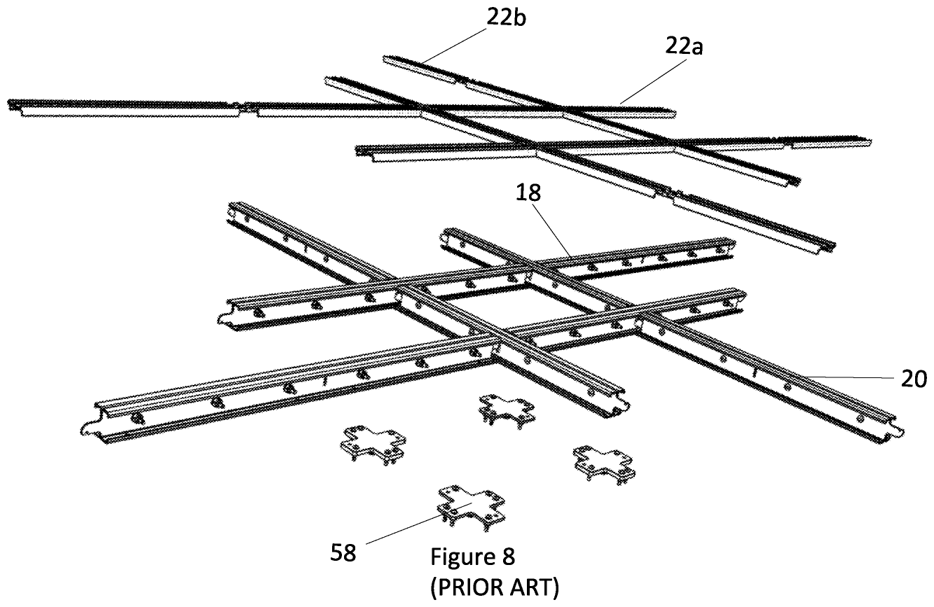

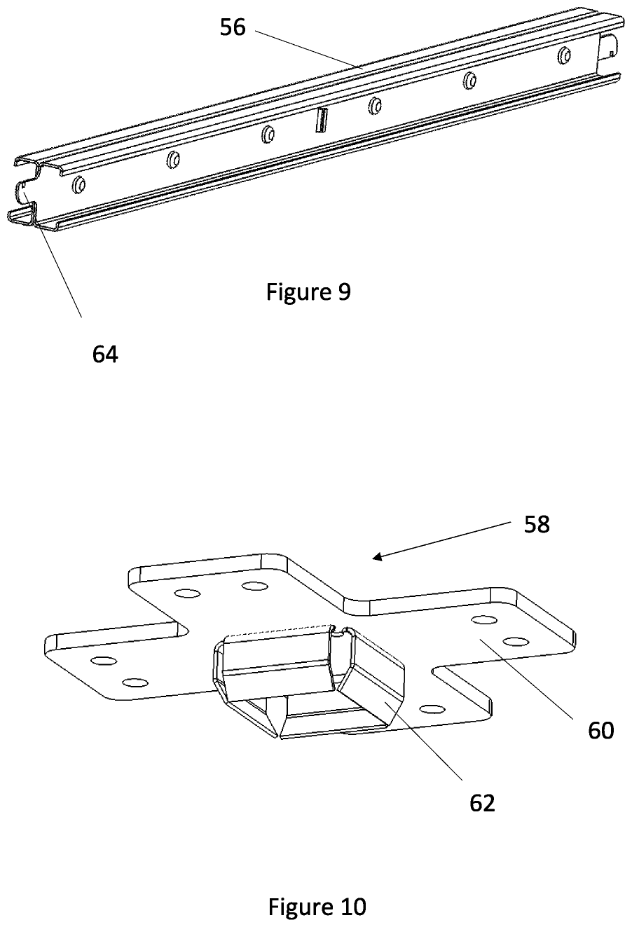

Each of the grid members can comprise a track support 18, 20 and/or a track or rail 22a, 22b (see FIG. 8) whereby the track or rail 22a, 22b is mounted to the track support 18, 20. A load handling device is operative to move along the track or rail 22a, 22b of the present invention. Alternatively, the track 22a, 22b can be integrated into the track support 18, 20 as a single body by extrusion. At least one grid member in a set, e.g. a single grid member, can be sub-divided or sectioned into discrete grid elements that can be joined or linked together to form a grid member 18, 20 extending in the first direction or in the second direction. Where the grid members comprise a track support, the track support can also be sub-divided into discrete track support elements that are linked together to form the track support. The discrete track support elements making up a track support extending in the first axial direction and in the second axial direction are shown in FIG. 8. An individual track support element 56 used to make up a track support 18, 20 is shown in FIG. 9. The track support element 56 of FIG. 9 is a double back-to-back C section bolted together.

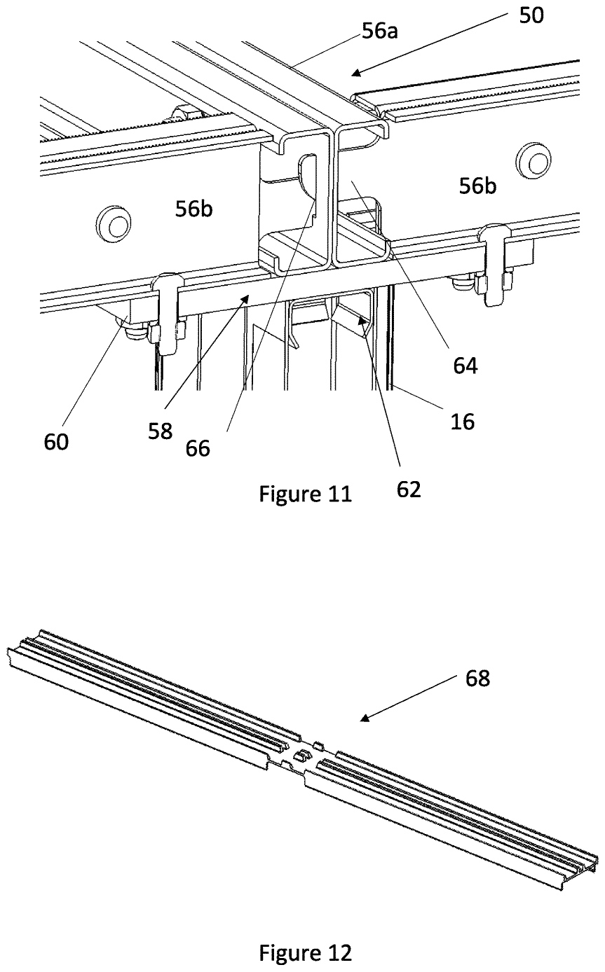

A connection plate or cap plate 58 as shown in FIG. 10 can be used to link or join the individual track support elements 56 together in both the first and the second direction at the junction where multiple track support elements cross in the track system 40, i.e. the cap plate 58 is used to connect the track support elements 56 together to the vertical uprights 16. As a result, the vertical uprights 16 are interconnected at their upper ends at the junction where the multiple track support elements cross in the track system 40 by the cap plate 58, i.e. the cap plate is located at the node 50 of the track system 40. As shown in FIG. 10, the cap plate 58 is cross shaped having four connecting portions 60 for connecting to the ends or anywhere along the length of the track support elements 56 at their intersections 50. The interconnection of the track support elements to the vertical uprights at the nodes by the cap plate 58 is demonstrated in the cross-sectional profile of the node 50 shown in FIG. 11. The cap plate 58 comprises a spigot or protrusion 62 that is sized to sit in the hollow central section 46 of the vertical upright 16 in a tight fit for interconnecting the plurality of vertical uprights 16 to the track support elements as shown in FIG. 11. Also shown in FIG. 11 are the track support elements 56a, 56b extending in both perpendicular directions corresponding to the first direction (x-direction) and the second direction (y-direction). The connecting portions 60 are perpendicular to each other to connect to the track support elements 56a, 56b extending in the first direction and in the second direction respectively. The cap plate 58 is configured to be bolted to the ends of the track support elements 56a, 56b or along the length of the track support elements. Each of the track support elements 56a, 56b is arranged to interlock with each other at the nodes to form the track system 40. To achieve this, distal or opposing ends of each of the track support elements 56a, 56b comprise locking features 64 for interconnecting to corresponding locking features 66 of adjacent track support elements. Opposing or distal ends of one or more track support elements comprise at least one hook or tongue 64 that is receivable in openings or slot 66 midway along an adjacent track support element 56 at the junction where the track support elements cross in the track system 40. Referring back to FIG. 9 in combination with FIG. 11, the hooks 64 at the end of a track support element 56 are shown received in an opening 66 of an adjacent track support element extending across a vertical upright 16 at the junction where the track support elements 56 cross. Here, the hooks 64 are offered up to an opening 66 either side of a track support element 56b. The opening 66 is halfway along the length of the track support element 56 so that when assembled together, adjacent parallel track support elements 56 in the first direction and in the second direction are offset by at least one grid cell. This is demonstrated in FIG. 8.

To complete the track system 40 once the track support elements are interlocked together in a grid pattern comprising track supports 18 extending in the first direction and track supports 20 extending in the second direction, a track 22a, 22b is mounted to the track support elements 56. The track 22a, 22b is either snap-fitted and/or fitted over the track support 18, 20 in a slide fit arrangement (see FIG. 8). Like the track support, the track comprises a first set of tracks 22a extending in the first direction and a second set of tracks 22b extending in the second direction, the first direction being perpendicular to the second direction. A first set of tracks 22a is sub-divided into multiple track elements 68 in the first direction such that, when assembled, adjacent parallel track elements in the first direction are offset by at least once grid cell. Similarly, a second set of tracks 22b is sub-divided into multiple track elements 68 in the second direction such that, when assembled, adjacent track elements in the second direction are offset by at least one grid cell. This is demonstrated in FIG. 8. An example of a single track element 68 is shown in FIG. 12. As with the track support elements, multiple track elements in the first direction and the second direction are laid together to form a track in both directions.

As can be appreciated from the above description, the process of assembling the grid framework structure involving erecting the vertical uprights, connecting the grid members and mounting the tracks is very time consuming since multiple separate components are necessary to assemble the grid framework structure. The process of erecting the grid framework structure can take several weeks and in a worst case scenario, the process can take several months. As the demand for e-commerce grows rapidly, particularly in the retail sector, there has been an increased demand for distribution centres, otherwise known as customer fulfilment centres (CFCs), in more locations rather than just a few locations that serve major cities in order to fulfil a growing demand from customers. The increased presence of distribution centres in more locations also has the effect of reducing the time to complete the last mile logistics for the movement of goods from the distribution centre to its final destination. Such last mile logistics is also an important consideration in order to keep goods such as perishable grocery products fresh at their final destination. One of the major bottlenecks to providing distribution centres in more locations is the time and cost to erect the grid framework structure. Not only is the time and cost to erect the grid framework structure a cause of concern when setting up a distribution centre, but also the grid framework structure should have the flexibility to be assembled in a number of existing locations including existing warehouses rather than bespoke warehouses purely to house the grid framework structure.

The above problem has been mitigated by using an adjustment mechanism to install a track system in a shorter period of time compared to the grid framework structure and track structure described above, while still maintaining the structural integrity of the track system for bearing the weight of one or more robotic load handling devices operative on the grid framework structure.

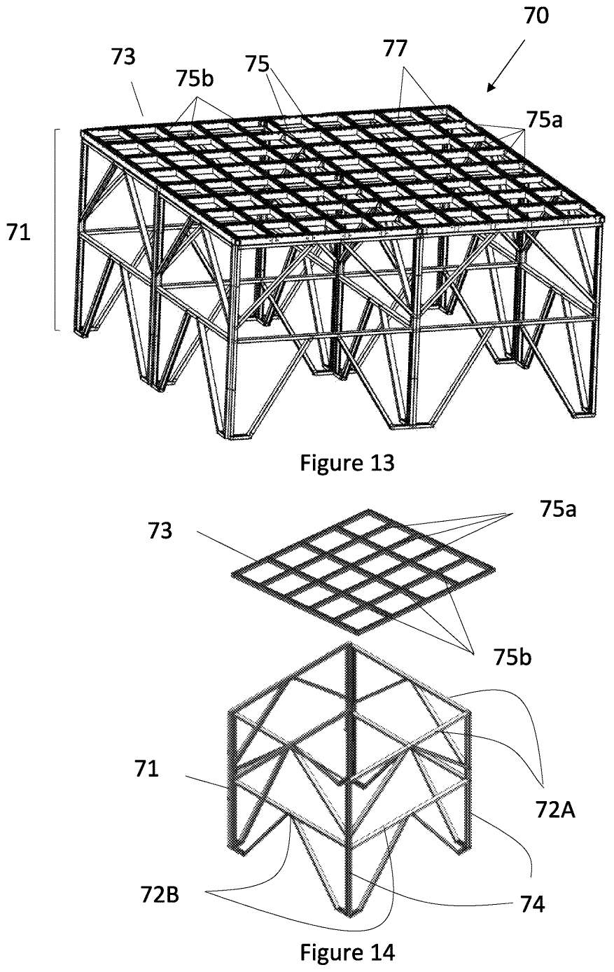

There is provided a track system 73 for guiding movement of one or more robotic load handling devices on a supporting framework structure 71. The combination of the track system 73 and the supporting framework structure 71 is termed a grid framework structure 70, as shown in FIG. 13. When assembling the grid framework structure 70, the supporting framework structure 71 is first assembled and then the track system 73 is mounted to the supporting framework structure 70. The track system 73 is raised above the ground by the supporting framework structure 71 to create an open storage space for the storage of multiple stacks of storage containers. The supporting framework structure 71 or the track system 73 or both the supporting framework structure 71 and the track system 73 can be assembled from modular structural components. In the particular embodiment shown in FIG. 13, both the supporting framework structure 71 and the track system 73 are assembled from prefabricated modular structural components to form a three dimensional grid framework structure 70. Each of the prefabricated frames comprises a plurality of vertical members 74 braced by horizontal bracing members 72. As shown in FIGS. 13 and 14, there are both upper horizontal bracing members 72A which form a frame on which the track system 73 is mounted, and lower horizontal bracing members 72B which together with the upper horizontal bracing members 72A increase the rigidity of the supporting framework structure 71.

The track system 73 is mounted to the supporting framework structure 71 such that the track system extends across a plurality of modular storage cells created a plurality of prefabricated frames, as shown in FIG. 13. The track system 73 comprises a plurality of tracks 75 arranged in a grid pattern comprising a plurality of grid cells 77. More specifically, the track system 73 comprises a first set of parallel tracks 75a extending in the first direction and a second set of parallel tracks 75b extending in the second direction, the second direction being substantially perpendicular to the first direction to adopt a grid like pattern.

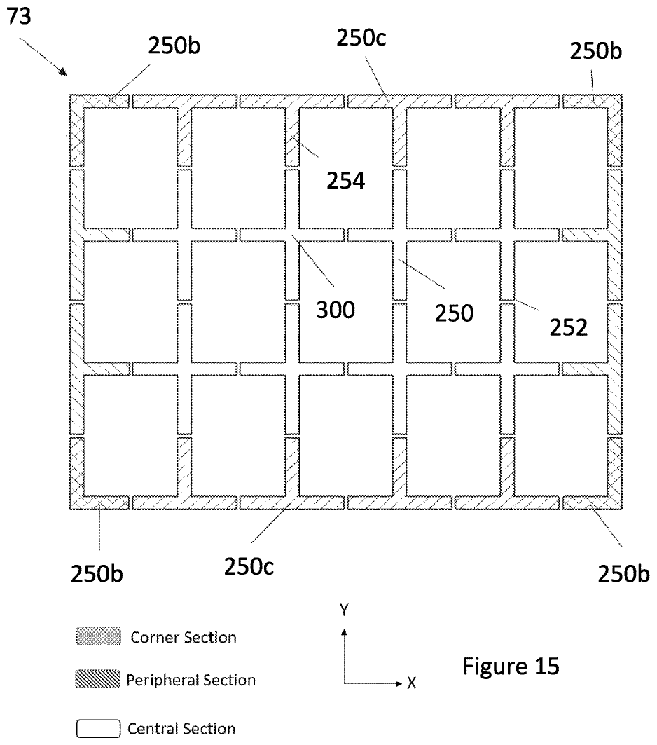

The different areas of the track system 73 where the track system has a rectilinear shape is shown in the sketch drawing of the pattern of the track sections in FIG. 15. The sketch of the pattern of track sections shown in FIG. 15 is not to scale and it is simply for illustration purposes. The track sections 250 at the corner section 250b of the track system 73 are shown with a different shaded area and each of the track sections 250b at the corner has two track elements 254, i.e. two branches. The track sections at the peripheral section 250c of the track system 73 are shown with a different shaded area. As shown in FIG. 15, each of the track sections 250c at the periphery of the track comprises three track elements 254, i.e. three branches. In the embodiment illustrated in FIG. 15, the track sections 250c at the periphery can have two track elements 254 extending in opposite directions along the first direction and a third track element 254 extending in the second direction, or two track elements 254 extending in opposite directions along the second direction and a third track element 254 extending in the first direction. The track sections 250c at the peripheral sections are not limited to having three track elements or branches 254 and can comprise more than three track elements depending on whether the peripheral section extends across more than one node 300. The nodes 300 represent the areas of the track system 73 where the individual track sections'250 elements or branches intersect. For example, a peripheral section can comprise two track elements extending in opposite directions along the first direction and multiple track elements extending in the second direction for connecting to or meeting with adjacent track sections in the central section of the grid structure, i.e. more than three branches.

As is clearly apparent in the schematic sketch shown in FIG. 15, a substantial portion of the track system falls within the central section of the track where each of the track sections 250 is cross shaped having track elements that branch or extend in transverse directions, i.e. first direction (X) and second direction (Y). In all of the differently shaped track sections 250, 250b, 250c in the particular embodiment shown in FIG. 15, there is a one to one relationship between each of the plurality of track sections and each of the nodes 300 of the track system. For example, there is a one to one relationship between a track section 250b and the node 300 at the corner of the track/grid structure. Likewise, there is a one to one relationship between each of the track sections 250c and each node 300 at the periphery of the track system.

However, it is also possible that a single track section can extend across more than one node in the track system. For example, the branches or track elements 254 of one or more of the track sections 250 can be sized to extend across one or more nodes of the track system. The larger sized track sections 250 would mean that fewer track sections 250 would be needed to make up the track system 73, i.e. to assemble the track system together. The distal ends 252 of one or more of the track elements 254 of adjacent track sections extend to meet between the nodes of the track system 73 as this is the area of the track system where the underlying track support is less susceptible to any vertical displacement. In all cases, each track section 250, 250b, 250c is a single unitary body having portions or elements 254 extending in transverse directions so as to provide a track surface or path for a load handling device to move on the track system extending in transverse directions. A single piece track section having a track surface or path extending in transverse directions greatly reduces the complexity and the components required to assemble the grid framework structure according to the present invention. Various materials can be used to fabricate the track section. These include various metals, e.g. aluminium, plastics, e.g. nylon and/or composite materials.

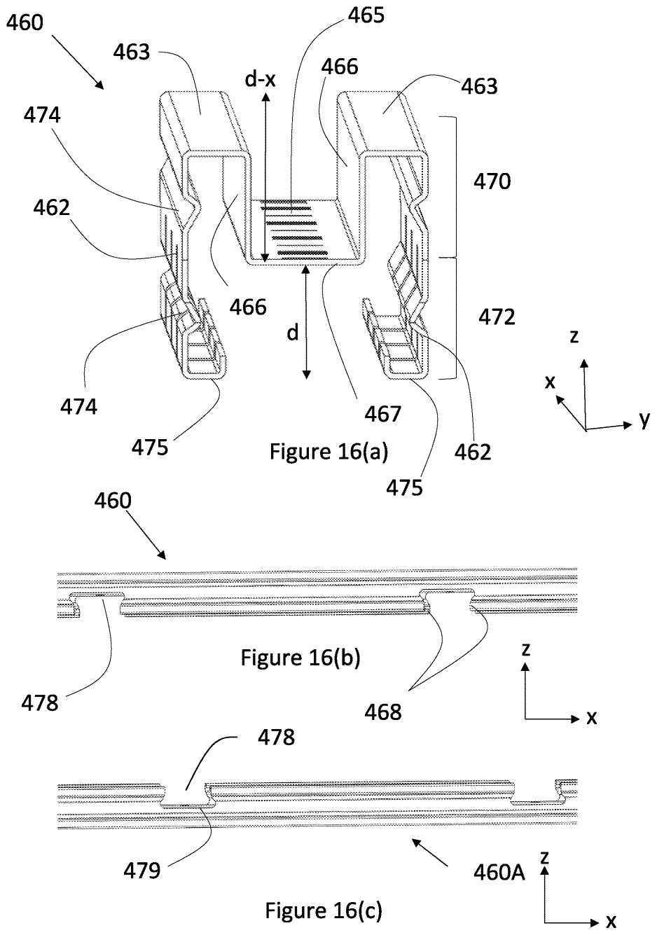

Beneath each of the track sections is a track support, such as the one shown in FIG. 16. The track support 460 is formed form a sheet metal blank. In particular, the sheet metal comprises steel, preferably galvanised steel. The sheet metal blank used for forming the track support of FIG. 16 is roll-formed into an H-shape as shown in FIG. 16(a). The track support 460 comprises a pair of vertical sides 462, a pair of horizontal flanges 463, and a U-shaped portion 465 located centrally within the track support 460. The U-shaped portion comprises a pair of vertical edges 466 extending parallel to and interiorly to the pair of vertical sides 462. The U-shaped portion 465 also comprises a horizontal edge 467 extending between the pair of vertical edges 466. Specifically, the horizontal edge 467 is positioned approximately centrally of the H-shape with respect to both the width and the height of the H-shaped track support.

The track support 460 comprises an upper portion 470 and a lower portion 472. The upper portion 470 comprises the pair of horizontal elevated flanges 463, the U-shaped portion 465 and approximately half the height of each of the vertical sides 462. The lower portion 472 comprises approximately half the height of each of the vertical sides 462. The vertical sides 462 comprise indentations 474 in both the upper portion 470 and the lower portion 472 to increase the rigidity of the track support. The free ends of the vertical sides 462 are folded inwards to further increase the rigidity of the track support and to create a horizontal base comprising a pair of horizontal base flanges 475.

Each track support is elongated in that it extends in either the x or y direction depending on the direction in which it is orientated. In particular, the track support 460 shown in FIG. 16(a) extends in the x direction. The track support may have a length of 4 grid cells thereby extending between 1.6 m and 3.2 m. Each track support comprises at least one cut-out 478. There may be a plurality of cut-outs 478 spaced along the length of the track support, as shown in FIG. 16(b) which is a side view of the track support of FIG. 16(a) along thex direction. There may be 2, 3, 4, 5, 6, 7, 8, 9, or 10 cut-outs 478 in each track support 260. The track support 460 comprises a plurality of pairs of protrusions 468, each pair of protrusions protruding into each of the cut-outs 478. FIG. 16(b) shows that the cut-outs 478 are facing downwards, but the same track support 460 can be rotated 180 degrees about the longitudinal direction such that the cut-outs 478 are facing upwards, as shown in FIG. 16(c). The same track supports can be used throughout the track system such that a second set of track supports 460A extending in a second direction have the cut-outs 478 facing upwards (as shown in FIG. 16(c)) and a first set of track supports 460 extending in a first direction have the cut-outs 478 facing downwards (as shown in FIG. 16(b)), wherein the second direction is substantially perpendicular to the first direction. The first set of track supports intersect the second set of tracks and vice versa at one or more nodes in the system and this is achieved by coupling each cut-out of the first set of track supports with each cut-out of the second set of track supports. The profile of each cut-out corresponds to at least a portion of the cross-sectional profile of the track support.

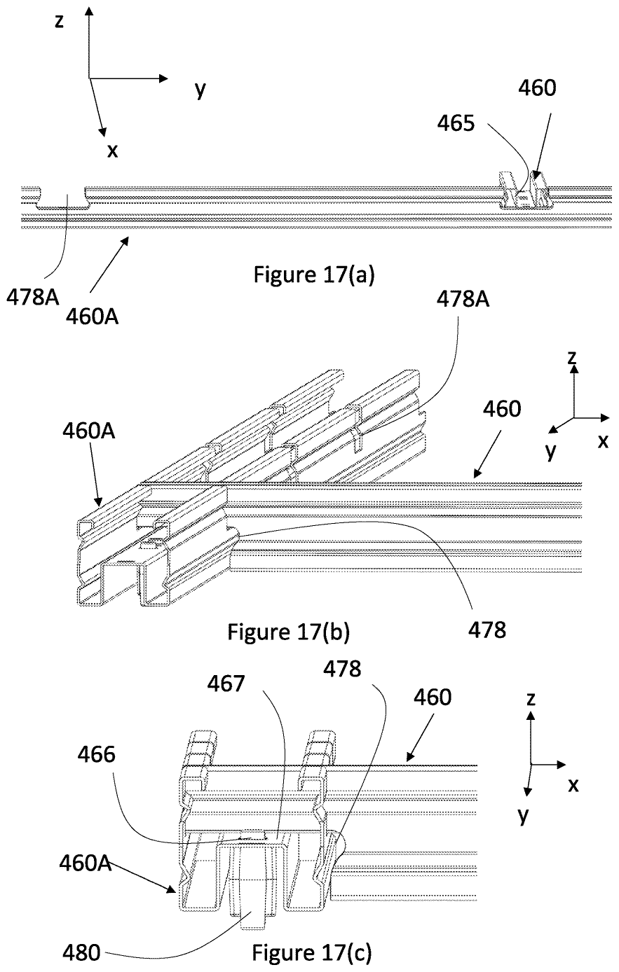

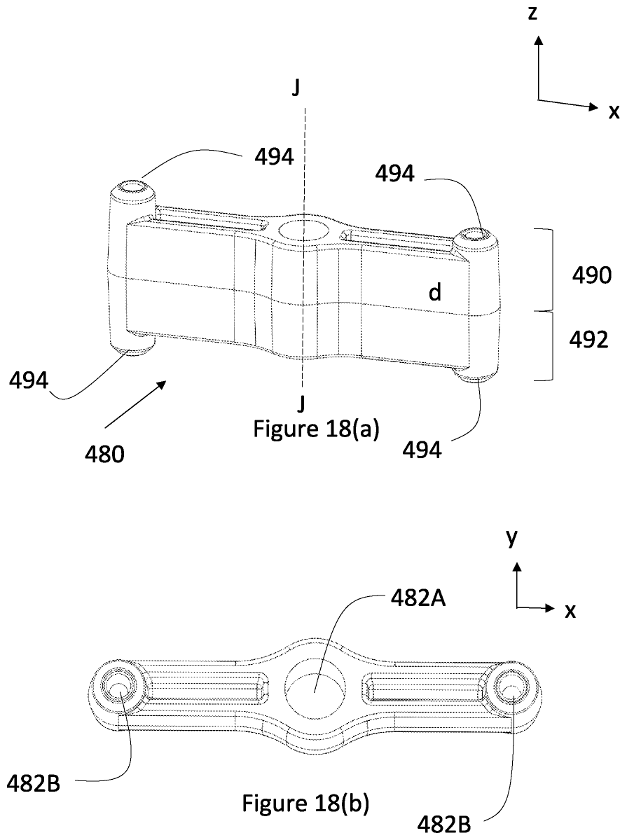

FIG. 17 shows the coupling of the cut-outs 478 of perpendicularly extending track support and the interaction between perpendicularly extending track supports more clearly. FIG. 17(a) illustrates a second track support 460A extending in a second direction and a first track support 460 extending in a first direction, the second direction being substantially perpendicular to the first direction. The second track support 460A comprises upwardly facing cut-outs 478A While the first track support 460 comprises downwardly facing cut-outs 478. Each downwardly facing cut-out 478 of the first track support 460 couples with each upwardly facing cut-out 478A of the second track support 460A at each node. This interaction can be achieved by aligning the downwardly facing cut-outs 478 of the first track support 460 with the upwardly facing cut-outs 478A of the second track support 460A and then lowering the first track support 460 onto the second track support 460A. Specifically, and as shown in FIG. 17(a) and (c), the U-shaped portion 465 of the first track support 460 rests on the U-shaped portion 465A of the second track support 460A. The vertical sides defining the cut-out 478 on the first track support touch the vertical sides defining the cut-out of the second track support 460A, therefore reducing movement of the first track support 460 along the second direction. Beneath the U-shaped portion of the second track support 460A is an adjustment mechanism 480 which is shown more clearly in FIG. 18. The adjustment mechanism device is located away from the node or intersection of the track supports. The adjustment mechanism 480 is a cast steel component that allows connection of the second support track 460A to the horizontal bracing member. As shown in FIG. 17(c), the adjustment mechanism 480 is connected to the second track support 460A by screws or bolts in the horizontal edge 467 of the U-shaped portion 465.

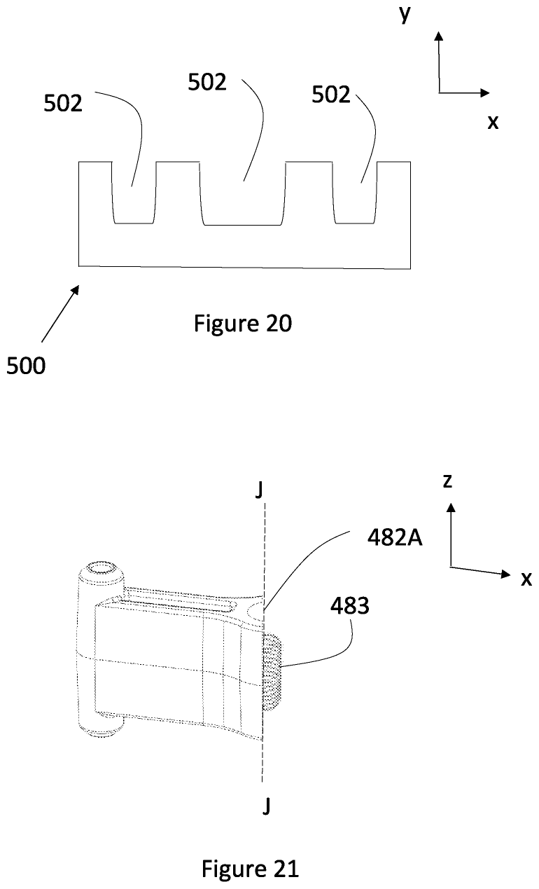

FIG. 18 illustrates the adjustment mechanism 480 in isolation. The adjustment mechanism 480 is an elongated component comprising an upper part 490 and a lower part 492. The upper part 490 and the lower part 492 each comprise a pair of raised positioning features 494. Each raised positioning feature 494 is located at each free end of the adjustment mechanism and each raised positioning feature 494 extends in a vertical direction (z-direction). The pair of raised positioning features 494 in the lower part 492 are shaped such that they fit within holes 76 formed in a top surface of an upper horizontal bracing member 72A. This is shown in FIG. 20. Similarly, the pair of raised positioning features 494 in the upper portion 490 are shaped such that they fit within holes 466 in the track support 460. The holes 466 in the track support 460 are located in the U-shaped portion, specifically in the horizontal edge 467 of the U-shaped portion 465, as shown in FIG. 17(c).

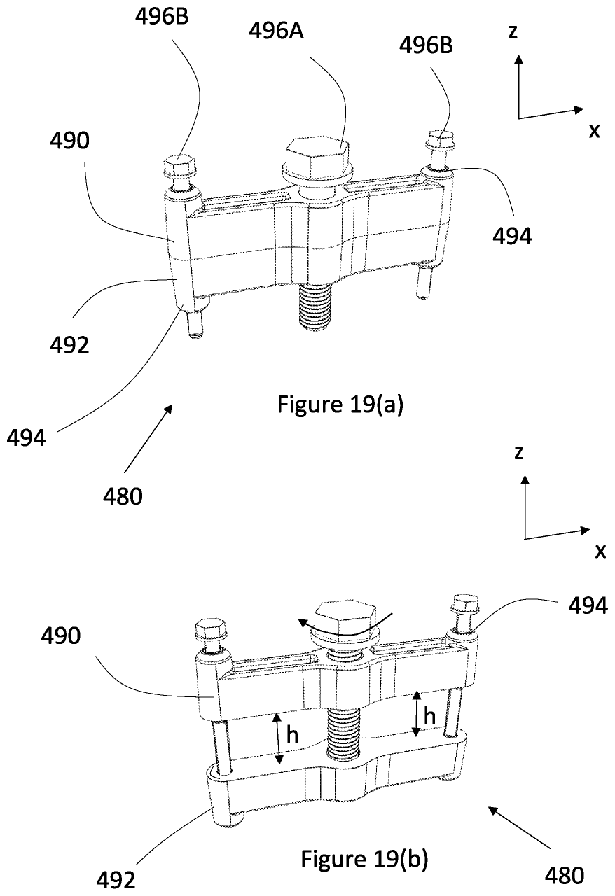

The adjustment mechanism comprises openings 482 that extend through both the upper part 490 and the lower part 492, i.e. the openings extend in a z (vertical) direction. One opening 482A is a threaded opening and is centrally positioned along the length (x direction) of the adjustment mechanism. The threaded opening 482A can threadingly engage with a threaded screw or bolt comprising a threaded shaft. The adjustment mechanism can therefore be attached to the track support and a horizontal bracing member of the supporting structure by the bolt or screw and a nut. Additionally, a pair of openings 482B are positioned within the raised positioning features 494 on either side of the adjustment mechanism, and extend in a z (vertical) direction down the raised positioning features 494 from the upper part 490 to the lower part 492. The pair of openings 482B are for inserting guide pins 496B, as shown in FIGS. 19(a) and (b).

The central bolt 496A may be rotated in a clockwise direction to increase the separation between the upper part 490 and the lower part 492, as shown in FIG. 19(b). Similarly, by rotating the bolts in an anti-clockwise direction, the separation between the upper part 490 and the lower part 492 decreases. The upper part 490 and lower part 492 may be held in a separated state by a spacer, in particular one or more shims which can be inserted in a space h between the upper part and the lower part. An example of a shim 500 is shown in FIG. 20. The shim 500 comprises openings 502 to allow the shin to be is slid into position between the upper part and the lower part. While one type of shim 500 is shown in FIG. 20, any other type of spacer may be used, such one or more nuts or one or more washers.

In an alternative embodiment, the adjustment mechanism may comprise a threaded shaft in the form of an insert. The threaded shaft 483 insert is shown in FIG. 21 in situ interiorly within the central opening 482A, and the adjustment mechanism is cut in half along the vertical line J-J, shown in FIG. 18(a). The threaded shaft 483 is positioned such that it extends along a portion of the upper part 490 and along a portion of the lower part 492. The threaded shaft 483 is hollow and comprises an interior passage which runs inside the vertical (Z-direction) length of the insert 483. The interior passage may be threaded to allow an external screw to be fitted into the interior passage so that the threaded shaft can be rotated to increase or decrease the separation between the upper part 490 and the lower part 492. Alternatively the interior passage may be shaped to fit an Allen key (or similar key) so that when the key is fitted into the interior passage, the key can be rotated thereby increasing or decreasing the separation between the upper part and the lower part of the adjustment mechanism. The threaded shaft 483 may be connectable to a bolt or screw at either or both of its free ends, to allow the adjustment mechanism to be attached to the track support 460 and the horizontal bracing member 72A. In this configuration, a bolt may either fit within the interior passage of the threaded shaft 483 to attach the adjustment mechanism to the horizontal bracing member 72A and a separate bolt may be fitted to an opposing end of the threaded shaft 483 to attach the adjustment mechanism to the track support. Alternatively, a bolt may fit within the interior passage of the threaded shaft 483 such that the bolt extends from the upper portion of the adjustment mechanism to the lower portion to allow a nut to be affixed to the free end of the bolt thereby connecting the adjustment mechanism to the horizontal bracing member 72A and the track support.

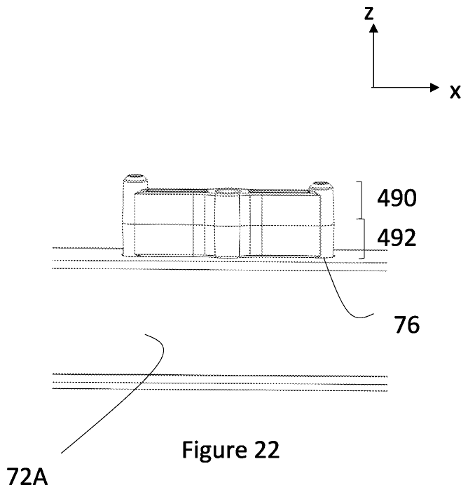

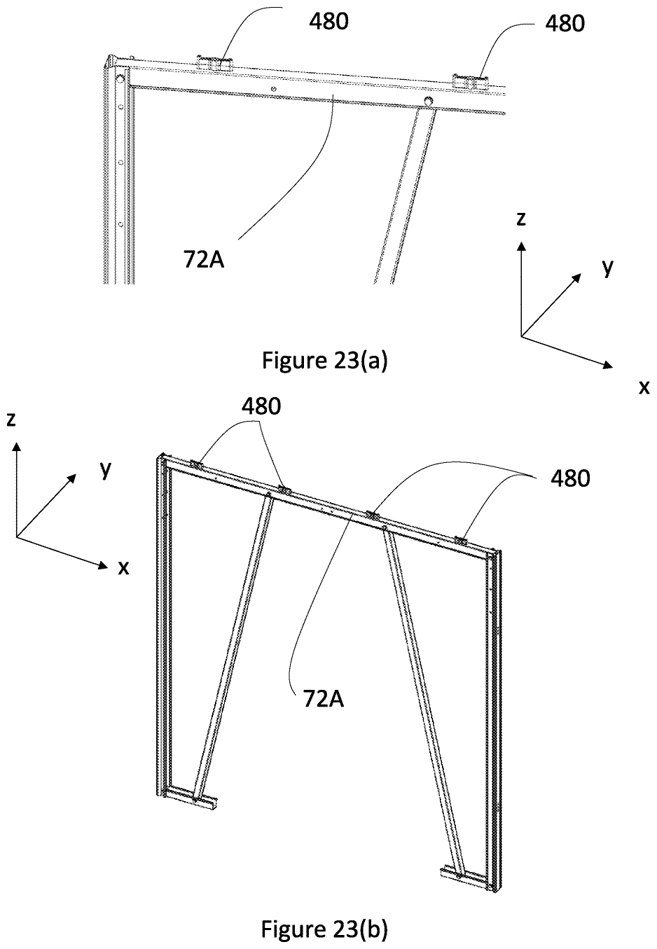

In order to position the adjustment mechanism in the grid framework structure, the adjustment mechanism is first placed onto an upper horizontal bracing member 72A so that the raised positioning features 494 of the lower part 492 fit into holes 76 in the upper horizontal bracing member 72A, as shown in FIG. 22. The adjustment mechanism is configured to be positioned such that it extends in the same direction as the length of the frame, for example the adjustment mechanism is positioned to extend in an x-direction along a frame component extending in the x-direction, and the adjustment mechanism is positioned to extend in a y-direction along a frame component extending in the y-direction. This is shown in FIG. 23(a), where two adjustment mechanisms 480 are orientated such that they extend in the x direction and are connected to a frame member which also extends in the x direction. FIG. 23(b) shows a complete frame member extending in the x direction and four adjustment mechanism positioned on top of the frame member and extending in the x direction also. The adjustment mechanisms are positioned away from the nodes between perpendicular track supports and are instead positioned under singular track supports positioned directly on the frame and extending in the same direction as the frame. As shown in FIG. 23, the adjustment mechanisms 480 are spaced apart at regular intervals. However, it is also possible that the adjustment mechanisms 480 are spaced apart at irregular intervals.

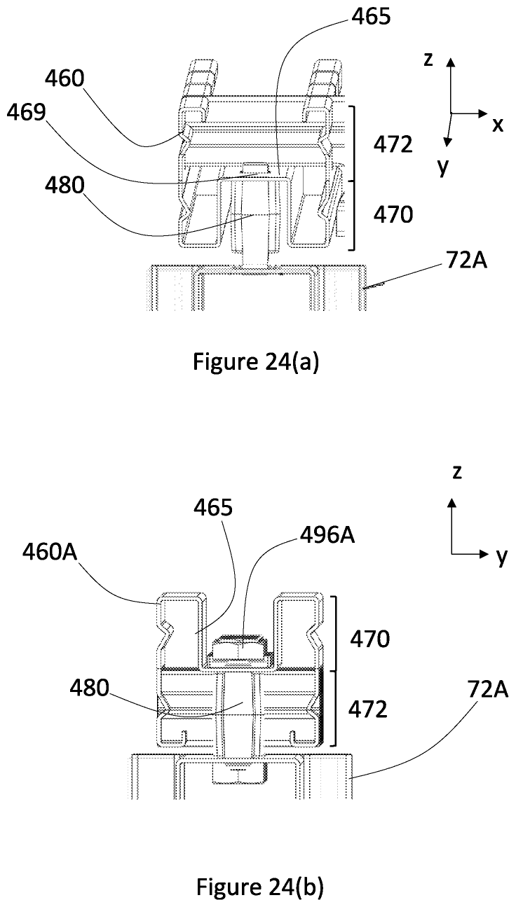

The adjustment mechanism is interposed between a track support 460 and a horizontal bracing member 72A of the supporting framework structure, as shown in FIG. 24. Depending on the orientation of the track support, the adjustment mechanism can be positioned directly beneath the U-shaped portion of the track support or within the U-shaped portion of the track support. In the configuration shown in FIG. 24(a), the adjustment mechanism is positioned within the U-shaped portion of the track support. In the configuration shown in FIG. 24(b), the track support is inverted, to form a second track support 460A which can intersect with the first track support 460 shown in FIG. 24(a). In FIG. 24(b), the adjustment mechanism is positioned below the U-shaped portion of the track support 460A. In both FIGS. 24(a) and (b), the track support 460 is positioned such that the holes 469 in the horizontal edge 467 of the U-shaped portion of the track support align with the raised positioning features 494 of the adjustment mechanism, such that the raised positioned features 494 are fitted within the holes 469. FIG. 24 shows the adjustment mechanism in position in the grid framework structure without the use of spacers. A survey of the track supports can then be carried out to determine whether the track supporting surface of the track supports is even across the grid pattern. If the track supporting surface is uneven, spacers can be added to the adjustment mechanism, as now described.

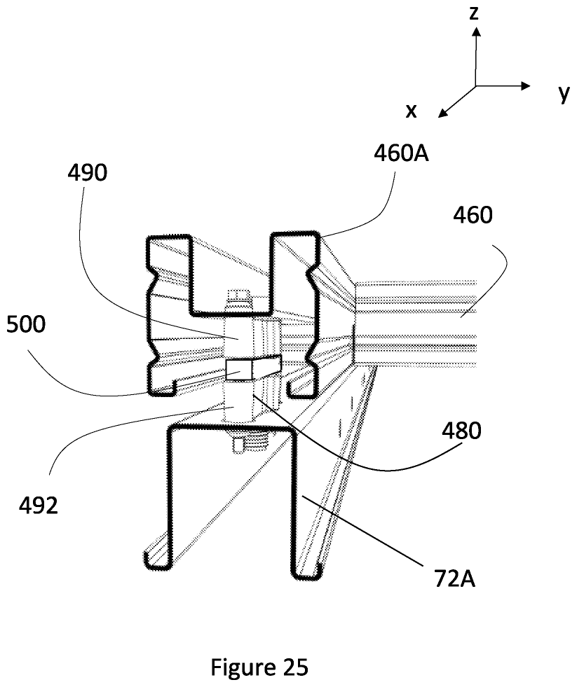

When the level of adjustment that is required is determined, a spacer, such as the shim 500 shown in FIG. 20, may be inserted between the upper part 490 and the lower part 492 of the adjustment mechanism 480, as shown in FIG. 25. The spacer, such as the shim 500, may be the exact height of adjustment that is required, or a plurality of spacers may be used to adjust the height. The one or more shims 500 may be slid into position between the upper part 490 and the lower part 492 of the adjustment mechanism.

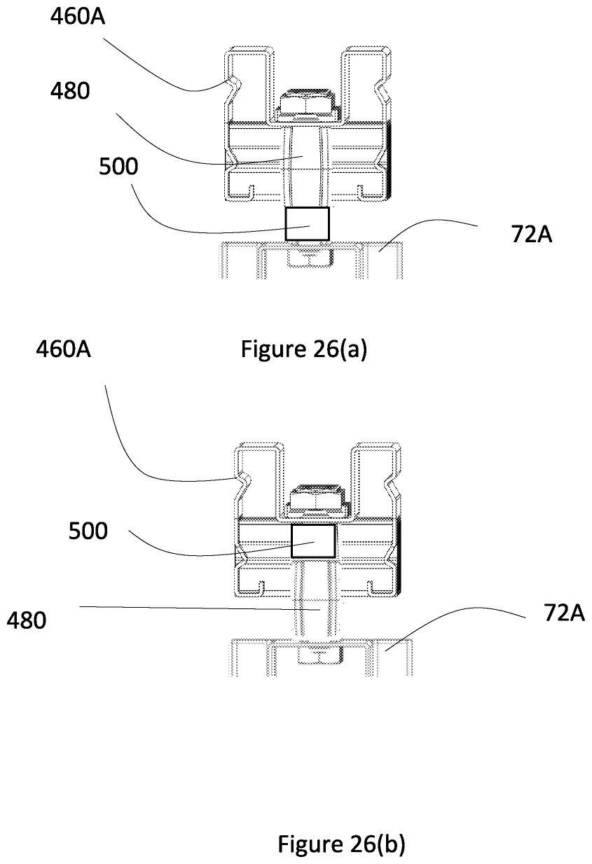

Alternatively, the separation between the track support 460 and the horizontal bracing member 72A may be adjusted by inserting one or more spacers, such as one or more shims 500 between the horizontal bracing member 72A and the adjustment mechanism 480, as shown in FIG. 26(a). In this arrangement, the upper part 490 and the lower part 492 are adjacent to each other, i.e. they are not separated.

Alternatively, the separation between the track support 460 and the horizontal bracing member 72A may be adjusted by inserting one or more spacers, such as one or more shims 500 between the adjustment mechanism 480 and the track support 460, as shown in FIG. 26(b). In this arrangement, the upper part 490 and the lower part 492 are adjacent to each other, i.e. they are not separated.

Once the level of the track support is set to a particular height, a nut can then be affixed to the free end of the central bolt 496A to attach the track support 460, adjustment mechanism 480 and horizontal bracing member 72A together.

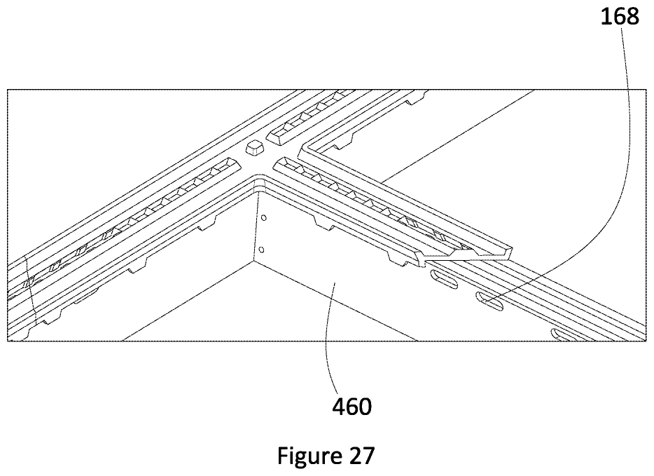

The track supports comprises slots or cut outs 490 on the vertical sides as shown in FIG. 27. The slots are spaced relatively evenly apart in FIG. 27 and each slot extends along a portion of the longitudinal length of the track support. The slots 490 provide a means of engagement between the track and the track support.

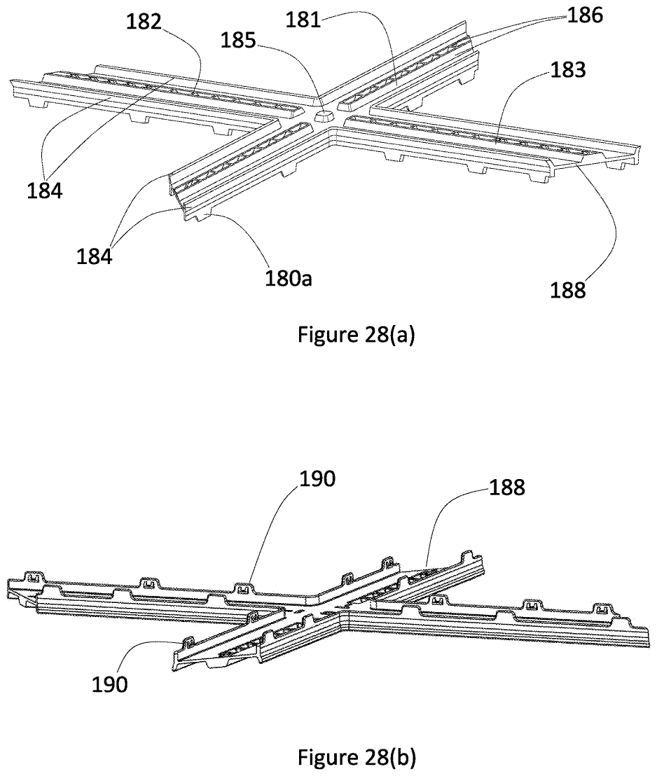

To secure the plurality of tracks to the track support structure, each of the track sections can be snap fitted to the track supports. As shown in FIG. 28(b), the underside of a track section comprises one or more lugs or tabs 190 that are configured to be snap fitted to the track support 160. The one or more lugs 190 can comprises a bead or protruding edge that is arranged to deflect and be received in one or more slots 168 in opposing vertical side walls (or vertical sides) 162 of the track support 160 in a snap fit arrangement. The snap fit feature may be a cantilever snap fit. However, other forms of snap fit connections commonly known in the art for securing the track section to the track support are applicable in the present invention. Equally, other forms of securing the track section to the track support besides a snap fit joint are applicable in the present invention, e.g. the use of fasteners or an adhesive.

In addition to thermal expansion of the different components of the supporting framework structure and the track support structure discussed above, one or more tracks of the plurality of tracks are also susceptible to thermal expansion. This is particularly the case where the plurality of tracks are separately mounted to the track supports. In the case, where the track is composed of a plastic material and the track support is largely composed of metal, there will be a disparity in the thermal expansion coefficients between the tracks and the underlying track support to the extent that there will be differential movement between both components as a result of thermal expansion. As each of the plurality of track sections comprises track elements extending in substantially transverse directions, relative movement between one or more of the plurality of track sections and the underlying track support structure are largely concentrated around the region of the track elements extending from the nodes of the track sections. A node in a track section is the area where the track elements in a given track section intersect. In the case, where the plurality of tracks are firmly secured to the underlying track support structure, differential movement between one or more of the plurality of tracks and the underlying track support as a result of the differences in thermal expansion between the track and the track support may cause the one or more of the tracks to distort. For example, where the underlying track support thermally expands to a greater extent than the track, the forces generated as a result of thermal expansion of the track support may have a tendency to impact the connection between the track and the track support. In a worst case scenario, the difference in thermal expansion between the track and the track support may result in the connection between the tracks and the track support failing ultimately leading to delamination or detachment of one or more tracks from the track support. As the plurality of track sections are snap-fitted to the track support structure, failure of the connection between the one or more of the plurality of tracks and one or more of the underlying track supports largely occurs at the snap-fitted joints between the plurality of tracks and the track support structure.

To mitigate the relative movement between the plurality of tracks and the underlying track support structure as a result of thermal expansion, the connection between each of the track sections and the underlying track support comprises a slip or movement joint. Where the connection between each of the plurality of track sections 180a and the underlying track support structure 160 comprises a snap-fitting joint, the snap-fitting joint between the track section and the track support is configured such that the connection allows one or more of the track elements 181, 182 to expand or contract along a substantially horizontal direction, i.e. along the plane in which the track system lies, but is prevented from movement in a substantially vertical direction to prevent the track section 180a from detaching from the underlying track support 160. To accommodate a thermal expansion joint within a snap-fitting joint, the one or more slots 168 in the opposing vertical side walls 162 of the track support 160 are enlarged in or more directions so as to permit movement of the lugs or tabs 190 within the one or more slots 168 in the track support 160. As shown in FIG. 27, each slot 168 is orientated such that the longest edge of the slot extends in the direction of the longitudinal length of the track support 160 and the shortest edge (i.e. width of the slot) extends in the direction substantially perpendicular to the longitudinal length of the track support. The orientation of the slot is such that the lugs or tabs 190 engaged with the slots 168 permits the lugs or tabs 190 to move along the slots 168 which in turn allows expansion or contraction of the track elements 181, 182 attached thereto relative to the underlying track support 160. Equally, plausible is that expansion or contraction of the underlying track support 160 as a result of thermal expansion causes the slots 168 to move relative to the lugs or tabs 190 engaged therein. Various other means to incorporate a slip or movement joint in the connection between one or more of the plurality of tracks and the underlying track support structure. For example, the connection between each of the plurality of tracks and the underlying track support structure can comprises one or more runners, e.g. telescopic drawer runners. Other means to provide one or more slip joints in the connection between each of the plurality of track sections, in particular the track elements of the track sections, include replacing the one or more slots in the opposing side walls of the track support with a depression that extends along the longitudinal length of the track support and configured to cooperate with the lugs or tabs of the tracks in a slide arrangement. Like the one or more slots, the one or more tabs or lugs of the track sections are configured to snap fit with the depression.

To accommodate for the thermal expansion of one or more of the plurality of track sections in the track system, the distal ends of the track elements 181, 182 of adjacent track sections 180a are spaced apart. The spacing is sufficient to allow the track elements of adjacent track sections to expand on the underlying track support such that their respective distal ends connect or butt-up without buckling. The spacing is also dependent of the diameter of the wheels of the robotic load handling device operable on the track system. If the spacing between the distal ends of adjacent track elements is too large in comparison to the diameter of the wheel, this has the effect of introducing a step between adjacent track elements causing the wheels of the robotic load handling device to snag or bump the ends of the track elements and in a worst case scenario cause the wheel to sink or fall within the gap created by the spacing between adjacent track elements. The spacing should be sufficient to allow the wheels of the robotic load handling device to traverse across the gap created by the spacing between the distal ends of adjacent track sections without excessive snagging of the wheels but not too big for the wheels to sink or fall within the gap. The spacing between the distal ends of adjacent track elements of adjacent track sections in the track system is comparable to the spacing between adjacent vertical uprights of adjacent prefabricated frames in the supporting framework structure, namely, the spacing is in the range 0.5 mm to 3 mm, preferably, between 1 mm to 2 mm, more preferably between 1.5 mm to 2 mm. The spacing between the distal ends of the track elements is largely influenced by the thermal expansion of one or more prefabricated frames of the supporting framework structure. Typically, for a wheel having a diameter of about 120 mm, the spacing can be up to 6 mm without excessive snagging or sinking of the wheels within the gap.

While endeavouring to draw attention to the features of the invention believed to be of particular importance, it should be understood that the applicant claims protection in respect of any patentable feature or combinations of features referred to herein, and/or shown in the drawings, whether or not particular emphasis has been placed on them. Many variations and modifications not explicitly described above are possible without departing from the scope of the invention as defined in the appended claims.

What is claimed is:

1. A grid framework structure for supporting one or more robotic load handling devices operative on the grid framework structure, the grid framework structure comprising:
i) a supporting framework structure comprising a plurality of prefabricated frames arranged in a three dimensional grid pattern comprising a plurality of modular storage cells for the storage of a plurality of stacks of containers such that adjacent modular storage cells share a common prefabricated frame, each of the plurality of prefabricated frames lying in a vertical plane and comprising a plurality of vertical members braced by one or more horizontal bracing members; and
ii) a track system for guiding movement of the one or more robotic load handling devices on the grid framework structure, the track system being mounted to the supporting framework structure and comprising a plurality of tracks arranged in a grid pattern comprising a plurality of grid cells extending across the plurality of modular storage cells such that each of the plurality of modular storage cells supports a sub-group of two or more grid cells of the track system;
wherein the grid framework structure comprises one or more adjustment mechanisms interposed between the one or more horizontal bracing members of the supporting framework structure and the track system for adjusting the level of the track system on the supporting framework structure.

2. A grid framework structure according to claim 1, wherein the track system further comprises a plurality of track supports arranged in a grid pattern comprising a first set of track supports extending in a first direction and a second set of track supports extending in a second direction, the second direction being substantially perpendicular to the first direction such that the first set of track supports intersect the second set of track supports at one or more nodes in the track system, and wherein the one or more adjustment mechanisms are interposed between the one or more horizontal bracing members of the supporting framework structure and the plurality of track supports.

3. A grid framework structure according to claim 1, wherein the one or more adjustment mechanisms comprises one or more openings, wherein at least one of the one or more openings is configured to threadingly engage with a threaded shaft.

4. A grid framework structure according to claim 3, wherein at least one of the one or more openings is configured to accommodate a guide pin.

5. A grid framework structure according to claim 1, wherein the one or more adjustment mechanisms each comprise an upper part and a lower part, wherein the upper part and the lower part are moveable relative to each other in a vertical direction to enable the separation between the one or more horizontal bracing members and the track system to be adjusted.

6. A grid framework structure according to claim 5, wherein the upper part and the lower part are separated by one or more spacers.

7. A grid framework structure according to claim 6, wherein the one or more spacers are slidingly engaged between the upper part and the lower part.

8. A grid framework structure according to claim 1, wherein the track system further comprises one or more spacers interposed between the adjustment mechanism and the track supports and/or between the supporting framework structure and the adjustment mechanism.

9. A grid framework structure according to claim 1, wherein the one or more adjustment mechanisms are attachable to the one or more horizontal bracing members and the track system.

10. A grid framework structure according to claim 1, wherein the one or more adjustment mechanisms extends in the same direction as the underlying horizontal bracing member beneath the adjustment mechanism and in the same direction as the track system above the adjustment mechanism.

11. A grid framework structure according to claim 1, wherein the one or more adjustment mechanisms each comprise at least one raised positioning feature, and the plurality of track supports and the one or more horizontal bracing members each comprise one or more holes for accommodating the at least one raised positioning feature of the one or more adjustment mechanisms.

12. A grid framework structure according to claim 11, wherein the at least one raised positioning feature comprises a pair of raised positioning features on a top surface of the adjustment mechanism and a pair of raised positioning features on a bottom surface of the adjustment mechanism.

13. A grid framework structure according to claim 1, wherein each of the one or more adjustment mechanisms comprises cast steel.

14. A grid framework structure according to claim1, wherein the one or more adjustment mechanisms comprise a plurality of adjustment assemblies.

15. A grid framework structure according to claim 14, wherein the plurality of adjustment mechanisms are spatially distributed in a direction along the length of the track system and/or one or more horizontal bracing members.

16. A grid framework structure according to claim 14, wherein each adjustment mechanism of the plurality of adjustment mechanisms is configured to adjust the level of at least a portion of the track system.

17. A grid framework structure according to claim 1, wherein the one or more adjustment mechanisms are positioned between nodes in the track system.
